(19) United States
(12) Patent Application Publication
(10) Pub. No.: US 2014/0001992 A1
(43) Pub. Date: Jan. 2, 2014

(54) Control Circuit with Frequency Hopping for Permanent Magnet Motor Control

(71) Applicant: SYSTEM GENERAL CORPORATION, New Taipei City (TW)

(72) Inventor: Ta-Yung YANG, Milpitas, CA (US)

(73) Assignee: SYSTEM GENERAL CORPORATION, New Taipei City (TW)

(21) Appl. No.: 13/649,247

(22) Filed: Oct. 11, 2012

Related U.S. Application Data
(60) Provisional application No. 61/665,461, filed on Jun. 28, 2012.

(51) Int. Cl. H02P 6/14

(52) U.S. Cl. 318/400.25

(57) ABSTRACT

A control circuit of a motor is provided. The control circuit includes a pulse width modulation circuit, a microcontroller, a timer and an analog-to-digital converter. The PWM circuit generates at least one switching signal coupled to drive the motor. The microcontroller having a memory circuit is coupled to control a switching frequency and a pulse with of the at least one switching signal. The switching frequency of said at least one switching signal is modulated in a frequency hopping manner for reducing an EMI. The pulse width of the at least one switching signal is modulated in response to the frequency hopping manner for keeping an average switching current of the motor as an approximate constant. The timer controlled by the microcontroller determines the switching frequency of the at least one switching signal. The analog-to-digital converter is coupled to detect an input voltage of the motor for the microcontroller.

### CROSS REFERENCE TO RELATED APPLICATIONS

This application claims the benefit of U.S. Provisional Application No. 61/665,461, filed on Jun. 28, 2012, the con tents of which are incorporated herein by reference.

### BACKGROUND OF THE INVENTION

1. Field of the Invention

The present invention relates to motor control, more particularly, relates to a control circuit of a permanent magnet motor.

2. Description of the Related Art

Normally a control circuit of a PM (permanent magnet) motor will generate high frequency (e.g. 20 kHz) switching signals to drive the motor. However, these high frequency switching signals will cause EMI (electromagnetic interference) problem. A frequency hopping technology has been developed to reduce the EMI. The skill of the frequency hopping or frequency jitter technology for reducing the EMI of the power supplies can be found in prior arts: “PWM controller having frequency jitter for power supplies”, U.S. Pat. No. 7,026,851; “Switching frequency jitter having output ripple cancel for power supplies”, U.S. Pat. No. 7,184,283; and “Switching controller having frequency hopping for power supplies”, U.S. Pat. No. 7,203,079.

### BRIEF SUMMARY OF THE INVENTION

The present invention provides a control circuit with frequency modulation for permanent magnet (PM) motors, such as brushless direct current (BLDC) motor, permanent magnet synchronous motor (PMSM) etc.

The present invention proposes a control circuit of a motor. An exemplary embodiment of a control circuit comprises a pulse width modulation (PWM) circuit, a microcontroller, a timer, and an analog-to-digital converter. The PWM circuit generates at least one switching signal coupled to drive the motor. The microcontroller having a memory circuit is coupled to control a switching frequency and a pulse with of the at least one switching signal. The switching frequency of said at least one switching signal is modulated in a frequency hopping manner for reducing an electromagnetic interference (EMI). The pulse width of the at least one switching signal is modulated in response to the frequency hopping manner for keeping an average switching current of the motor as an approximate constant. The pulse width of the at least one switching signal is modulated in response to the frequency hopping manner for keeping a torque of the motor as an approximate constant. The timer which is controlled by the microcontroller determines the switching frequency of the at least one switching signal. The PWM circuit comprises a counter, a first register, a second register, and a comparator. The counter generates a waveform signal. The first register determines a waveform of the waveform signal. The second register generates a threshold. The comparator generates the switching signal in response to the threshold and the waveform signal. The analog-to-digital converter is coupled to detect a switching current of the motor for the microcontroller. The analog-to-digital converter is coupled to detect an input voltage of the motor for the microcontroller. The switching frequency of the at least one switching signal is modulated in response to a change of the input voltage of the motor.

The present invention also proposes a method of controlling a motor. An exemplary embodiment of a method comprises: generating a switching signal coupled to drive the motor; and modulating a switching frequency of the switching signal for reducing an electromagnetic interference (EMI). A pulse width of the switching signal is modulated in response to a frequency hopping manner of the switching signal for keeping an average switching current of the motor as an approximate constant. The pulse width of the switching signal is modulated in the frequency hopping manner for keeping a torque of the motor as an approximate constant. The switching frequency and the pulse width of the switching signal are controlled by a microcontroller having a memory circuit. The switching frequency of said switching signal is determined by a timer, and the timer is controlled by the microcontroller. The average switching current of the motor is detected by an analog-to-digital converter. The analog-to-digital converter is coupled to the microcontroller.

The present invention further proposes a control circuit of a motor. An exemplary embodiment of a control circuit comprises a pulse width modulation (PWM) circuit and a microcontroller having a memory circuit. The PWM circuit generates a switching signal coupled to drive the motor. The microcontroller is coupled to control a switching frequency and a pulse with of the switching signal. The switching frequency of said switching signal is modulated in response to a change of an input voltage of the motor. The pulse width of the switching signal is modulated in a frequency hopping manner of the switching signal for keeping an average switching current of the motor as an approximate constant. The pulse width of the switching signal is modulated in the frequency hopping manner to a frequency modulation of the switching signal for keeping a torque of the motor as an approximate constant.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an embodiment of a permanent magnet motor control system according to the present invention;

FIG. 2 shows an embodiment of a PWM circuit of the permanent magnet motor control system in FIG. 1 according to the present invention;

FIG. 3 shows an embodiment of PWM controllers of the PWM circuit in FIG. 2 according to the present invention;

FIG. 4 shows the waveforms of a waveform signal, a threshold and a driving signal of the permanent magnet motor control system in FIG. 1; and

FIG. 5 shows the waveforms of the threshold and the curve of the switching frequency in a control method according to the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

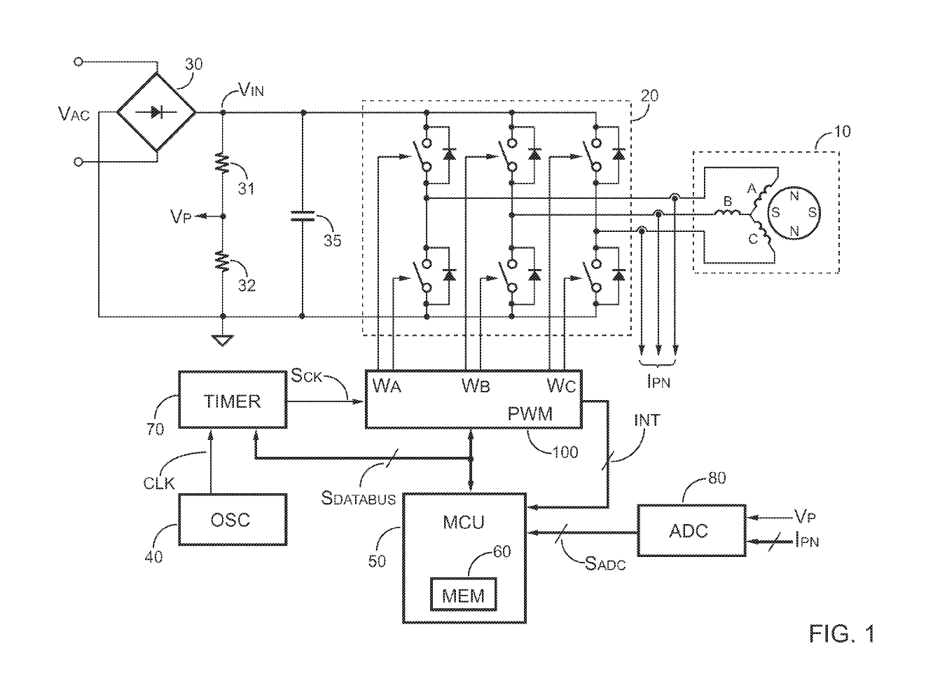

FIG. 1 shows an exemplary embodiment of a permanent magnet motor control system according to the present invention. The system comprises a bridge rectifier 30, a voltage divider formed by resistors 31 and 32, an input capacitor 35, a driving circuit 20, a permanent magnet motor 10, and a control circuit. The control circuit comprises a PWM (pulse width modulation) circuit (PWM) 100, a timer 70, an oscillator (OSC) 40, an analog-to-digital converter (ADC) 80, and a microcontroller (MCU) 50 having a memory circuit (MEM) 60. The PWM circuit 100 generating switching signals W_{A}, W_{B}, and W_{C} is coupled to drive the permanent magnet motor 10 via the driving circuit 20. The driving circuit 20 will generate a plurality of switching current signals I_{PN} in response to the switching currents of the permanent magnet motor 10. An input voltage V_{IN} of the driving circuit 20 is generated from an AC power source V_{AC} via the bridge rectifier 30 and the input capacitor 35. The voltage divider is coupled between the input voltage V_{IN} and a ground reference for generating an input signal V_{P}. A level of the input signal V_{P} is correlated to the amplitude of the input voltage V_{IN}. The microcontroller 50 having the memory circuit 60 is utilized to control the PWM circuit 100 for controlling the permanent magnet motor 10. The oscillator 40 generates a clock signal CLK for the control circuit. The clock signal CLK is supplied to the timer 70 for producing a programmable clock signal S_{CK}. The timer 70 is controlled by the microcontroller 50 through a data bus S_{DATABUS} of the microcontroller 50. Thus, the frequency of the programmable clock signal S_{CK} is determined by the microcontroller 50. The programmable clock signal S_{CK} is further coupled to the PWM circuit 100 for determining the switching frequency of the switching signals W_{A}, W_{B}, and W_{C}. The analog-to-digital converter 80 is coupled to receive the switching current signals I_{PN} and the input signal V_{P}, and generate signals S_{ADC} in response to the switching current signals I_{PN} and the input signal V_{P} for the microcontroller 50.

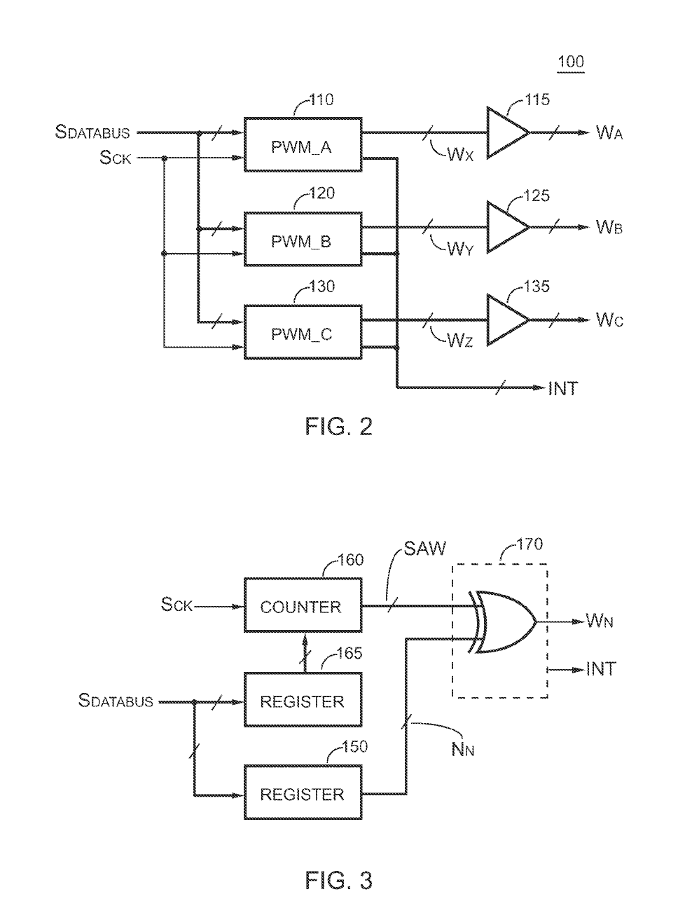

FIG. 2 shows an exemplary embodiment of the PWM circuit 100 according to the present invention. The PWM circuit 100 comprises PWM controllers (PWM_A, PWM_B, and PWM_C) 110, 120, and 130 and output buffers 115, 125, and 135. The PWM controllers 110, 120, and 130 are coupled to receive the programmable clock signal S_{CK} and further coupled to the data bus S_{DATABUS} of the microcontroller 50 for generating signals W_{X}, W_{Y}, and W_{Z}. The signals W_{X}, W_{Y}, and W_{Z} are supplied to inputs of the output buffers 115, 125, and 135 respectively to generate the switching signals W_{A}, W_{B}, and W_{C}.

The PWM controllers 110, 120, and 130 will also generate an interrupt signal INT in response to the generation of the signals W_{X}, W_{Y}, and W_{Z}. The interrupt signal INT is further coupled to interrupt the microcontroller 50.

FIG. 3 shows an exemplary embodiment of the PWM controllers 110, 120 and 130 according to the present invention. Each PWM controller comprises a counter 160, registers 150 and 165, and a comparator 170. The counter 160 is coupled to receive the programmable clock signal S_{CK} for generating a waveform signal SAW. The counter 160 is controlled by the register 165. The data stored in the register 165 determines the waveform of the waveform signal SAW. The waveform signal SAW could also come in saw-tooth waveform or triangle waveform. The data stored in the register 165 is loaded from the data bus S_{DATABUS} of the microcontroller 50. The data bus S_{DATABUS} of the microcontroller 50 also controls another register 150 for generating a threshold N_{N}. The threshold N_{N} and the waveform signal SAW are coupled to the comparator 170 for generating a driving signal W_{N}, such as the signals W_{X}, W_{Y}, and W_{Z}. A higher value of the threshold N_{N} will generate a wider pulse width of the driving signal W_{N}. The comparator 170 further generates the interrupt signal INT in response to the generation of the driving signal W_{N}. Through the control of the timer 70, the counter 160, and the registers 150 and 165, the switching frequency and the pulse width of the switching signals W_{A}, W_{B}, and W_{C} are determined and controlled by the microcontroller 50.

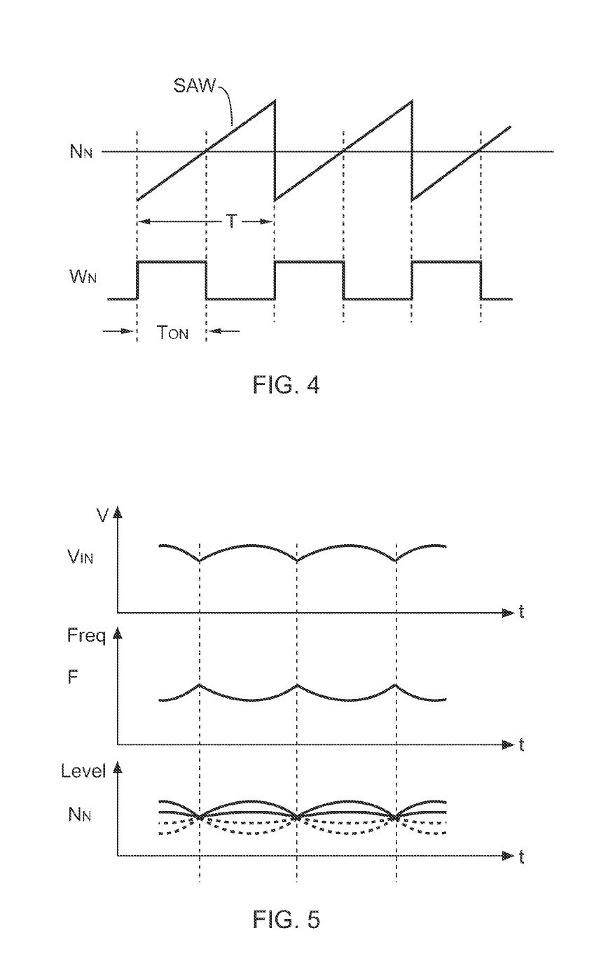

FIG. 4 shows the waveforms of the waveform signal SAW, the threshold N_{N} and the driving signal W_{N}, where T represents the switching period of the waveform signal SAW; T_{ON} represents the pulse width (on-time) of the driving signal W_{N}. The switching frequency of the switching signals W_{A}, W_{B}, and W_{C} can be expressed as equation (1). The value of T_{ON} is determined by the waveform signal SAW, the threshold N_{N}, and the microcontroller 50.

The switching current signals I_{PN} are coupled to the microcontroller 50 via the analog-to-digital converter 80. Therefore, the microcontroller 50 will get the value of the average switching current I_{SW} by equation (2).

$$\begin{matrix}F = \frac{1}{T} & ( 1 ) \\ {I}_{SW} = \frac{{T}_{ON}}{T} \times {I}_{PN} & ( 2 )\end{matrix}$$

When the switching period (T) and switching frequency (F) of the switching signals W_{A}, W_{B}, and W_{C} are modulated (programmed by the microcontroller 50) in the frequency hopping manner for reducing the EMI, the microcontroller 50 will adjust the pulse width T_{ON} of the switching signals W_{A}, W_{B}, and W_{C} in a frequency hopping manner accordingly to keep the average switching current I_{SW} as an approximate constant. Keeping the average switching current I_{SW} constant will also keep the torque of the permanent magnet motor 10 as an approximate constant. Equations (3) and (4) show the function of the motor's torque.

Torque=K_{T}×I_{SW} (3)

Torque=K_{T}×[(V_{T}−K_{E}×N_{P})÷R_{L}] (4)

Where K_{T} is a torque constant; V_{T} is the terminal voltage of the motor (it is related to the input voltage V_{IN} of the permanent magnet motor 10); K_{E} is a Back-EMF constant; N_{P} is the rotation speed of the permanent magnet motor 10; R_{L} is the winding resistance of the permanent magnet motor 10.

FIG. 5 shows the waveforms of the threshold N_{N} and the curve of the switching frequency F in a control method. The threshold N_{N} and the curve of the switching frequency F are varied in response to the change of the input voltage V_{IN} (also in response to the change of the input signal V_{P}). The switching frequency of the signals W_{A}, W_{B}, and W_{C} is decreased in response to the increment of the input voltage V_{IN}. The level of the threshold N_{N} and the pulse width T_{ON} of the switching signals W_{A}, W_{B}, and W_{C} will be modulated accordingly to achieve an approximated constant torque.

Another exemplary embodiment of a control method comprises following two steps:
(a) Varying the switching frequency of the signals W_{A}, W_{B}, and W_{C} in response to a pattern or a module in the memory circuit 60.
(b) Varying the level of the threshold N_{N} (and the pulse width T_{ON}) in a frequency hopping manner of the switching signals W_{A}, W_{B}, and W_{C} to control the average switching current I_{SW} and the torque of the permanent magnet motor 10 as approximate constant.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control circuit of a motor, comprising:
a pulse width modulation (PWM) circuit, generating at least one switching signal coupled to drive said motor; and
a microcontroller having a memory circuit, coupled to control a switching frequency and a pulse with of said at least one switching signal,
wherein said switching frequency of said at least one switching signal is modulated in a frequency hopping manner for reducing an electromagnetic interference (EMI).

2. The control circuit as claimed in claim 1, wherein said pulse width of said at least one switching signal is modulated in said frequency hopping manner for keeping an average switching current of said motor as an approximate constant.

3. The control circuit as claimed in claim 1, wherein said pulse width of said at least one switching signal is modulated in said frequency hopping manner for keeping a torque of said motor as an approximate constant.

4. The control circuit as claimed in claim 1, further comprising:
a timer, determining said switching frequency of said at least one switching signal, wherein said timer is controlled by said microcontroller.

5. The control circuit as claimed in claim 1, wherein said PWM circuit comprises:
a counter, generating a waveform signal;
a first register, determining a waveform of said waveform signal;
a second register, generating a threshold; and
a comparator, generating said switching signal in response to said threshold and said waveform signal.

6. The control circuit as claimed in claim 1, further comprising
an analog-to-digital converter, coupled to detect a switching current of said motor for said microcontroller.

7. The control circuit as claimed in claim 6, wherein said analog-to-digital converter is coupled to detect an input voltage of said motor for said microcontroller, and said switching frequency of said at least one switching signal is modulated in response to a change of said input voltage of said motor.

8. A method of controlling a motor, comprising:
generating a switching signal coupled to drive said motor; and
modulating a switching frequency of said switching signal for reducing an electromagnetic interference (EMI),
wherein a pulse width of said switching signal is modulated in a frequency hopping manner of said switching signal for keeping an average switching current of said motor as an approximate constant.

9. The method as claimed in claim 8, wherein said pulse width of said switching signal is modulated in said frequency hopping manner for keeping a torque of said motor as an approximate constant.

10. The method as claimed in claim 8, wherein said switching frequency and said pulse width of said switching signal are controlled by a microcontroller having a memory circuit.

11. The method as claimed in claim 8, wherein said switching frequency of said switching signal is determined by a timer, and said timer is controlled by said microcontroller.

12. The method as claimed in claim 8, wherein said average switching current of said motor is detected by an analog-to-digital converter, and said analog-to-digital converter is coupled to said microcontroller.

13. A control circuit of a motor, comprising:
a pulse width modulation (PWM) circuit, generating a switching signal coupled to drive said motor; and
a microcontroller having a memory circuit, coupled to control a switching frequency and a pulse with of said switching signal;
wherein said switching frequency of said switching signal is modulated in response to a change of an input voltage of said motor.

14. The control circuit as claimed in claim 13, wherein said pulse width of said switching signal is modulated in a frequency hopping manner of said switching signal for keeping an average switching current of said motor as an approximate constant.

15. The control circuit as claimed in claim 13, wherein said pulse width of said switching signal is modulated in a frequency hopping manner of said switching signal for keeping a torque of said motor as an approximate constant.
